(19) United States
(12) Patent Application Publication
(10) Pub. No.: US 2012/0113625 A1
(43) Pub. Date: May 10, 2012

(54) UNIVERSAL SOLAR ILLUMINATOR SYSTEM

(76) Inventors: Joey D. Werner, Battle Creek, MI (US); William L. Johnson, Battle Creek, MI (US)

(21) Appl. No.: 13/290,647

(22) Filed: Nov. 7, 2011

Related U.S. Application Data
(60) Provisional application No. 61/410,529, filed on Nov. 5, 2010.

(51) Int. Cl. F21L 4/08

(52) U.S. Cl. 362/183

(57) ABSTRACT

A universal solar illuminator system (100) is mounted to a flagpole apparatus (102) having a flagpole (104) and flag (106). The illuminator system (100) includes an elongated structure (120) opening outwardly and exposing a recessed area (123) having a rear, curved surface (125). The system (100) also includes an LED network (126) having a series of LED's (124) energized through a DC circuit (127) from a series battery pack (138). Solar panels (150, 152) charge the series battery pack (138) during daylight conditions.

### CROSS-REFERENCE TO RELATED APPLICATIONS

This application is based on and claims priority of U.S. Provisional Patent Application Ser. No. 61/410,529 filed Nov. 5, 2010.

### STATEMENT REGARDING FEDERALLY SPONSORED RESEARCH OR DEVELOPMENT

Not applicable.

### PARTIES TO A JOINT RESEARCH AGREEMENT

Not applicable.

### REFERENCE TO A SEQUENCE LISTING

Not applicable.

### BACKGROUND OF THE INVENTION

1. Field of the Invention

The invention relates to means for producing lighting effects as powered by solar apparatus and, more particularly, lighting effects which may be adapted for use with displays of flags or other banners.

2. Background Art

Ever since the advent of electrical lighting apparatus, a substantial amount of development has been undertaken for achieving new applications for use of lighting effects in various environmental conditions and applications. These applications have involved both functional use of electric light (e.g. street lamps, stop lights and general lighting for visual use), as well as decorative and commercial functions (e.g. advertisement lighting, Christmas displays and the like). In this regard, a number of the decorative lighting applications which have been developed over the past few decades have involved outdoor lighting. For example, outdoor lighting is often used with landscape designs, not only to provide light for landscape displays, but also for such applications as garden pathway lighting and the like (which can involve both decorative and functional (i.e. safety) uses). Another use of primarily outdoor lighting is associated with the display of flags or banners. However, one difficulty associated with any type of lighting application, particularly with respect to those involving outdoor use, is to provide for a convenient source of electrical power. That is, outdoor lighting displays are often located a substantial distance away from any conventional sources of commercial power. Also, connecting lighting displays to remote sources of power can involve unsightly (and sometimes dangerous) electrical cords or other connection means. Accordingly, for a number of applications, alternative forms of power sources have been studied. One of these sources is solar power.

With respect to the general concepts associated with providing for lighting displays associated with flags, flagpoles and other banners, a substantial amount of work has been completed. For example, Lawrence et al., U.S. Pat. No. 7,275,495 issued Oct. 2, 2007 is directed to the application of a beacon or light for purposes of illuminating a pole-mounted, halyard-hoisted flag, banner, pennant or the like. The beacon or light is in the form of a luminous source located within a cover. The luminous source is capable of continuously directing a narrow beam of light toward the flag, banner, pennant or the like as circulating wind will blow the same about the flagpole itself. The flagpole beacon is expressly disclosed as being designed to replace the knob of an existing pole, and may be used on poles having either an internal halyard configuration, or an external halyard configuration. The Lawrence et al. patent generally discloses a concept that pole mounted flags and the like typically represent a source of pride to those who display the same. However, such flags and the like cannot be adequately displayed at night because of poor visibility. Accordingly, for a significant period of time, it has been known to make attempts to illuminate such flags, so that they remain visible both during the day and the evening.

In the past, it has been relatively common to accomplish the evening visibility through the use of a floodlight located on the ground and pointed upwardly towards the sky in the general direction of a pole mounted flag. However, depending, for example, on the voltage range used, installation of the floodlight may require application for and obtaining a license. Also, floodlights are often expensive to purchase, expensive to operate on a daily basis, and difficult to use and maintain. In addition, the intensely bright, broad beam from a floodlight will typically illuminate more of the sky than the flag. This provides unsatisfactory visibility for the flag, and adds to the not-insignificant problem of atmospheric light pollution.

In view of such drawbacks, especially with floodlights, it has also been known to make attempts to illuminate pole mounted flags and the like through the mounting of light sources in close proximity to the flag. Such sources are typically positioned at or near the top of the pole. An early patent, mainly U.S. Pat. No. 1,660,341, discloses the attachment of a translucent closure to the upper end of the pole, and placement of a light source inside the closure to project rays of lights upon the flying flag. Although such a device allows for the use of less light than is required by a floodlight, the device still does not solve the problem of illuminating more of the surrounding sky, than of the flag itself

Other known configurations have incorporated the use of reflective surfaces above the light source, in order to direct the light downwardly toward the flag. Such a configuration is shown in U.S. Pat. No. 3,476,929, which describes the mounting of a reflector cone to the top of the pole. A light source is positioned within the reflector cone, and an inner surface of the cone is coated with a reflective material. A base includes four lenses for light to pass through. With this design, light from the light sources is reflected downwardly by the reflective material through the lenses, so as to illuminate the area around the pole.

Another configuration is disclosed in U.S. Pat. No. 6,227,683. In the '683 patent, a knob is utilized which has a light source within the knob. A cover, having an upper portion opaque and a lower portion translucent, is also used. A reflective surface is located inside the cover, but above the light source. With this configuration, light from the light source is reflected downwardly by the reflecting surface through the translucent lower portion of the cover, so as to illuminate the area around the pole. Although these devices reduce the amount of atmospheric light pollution by focusing the light in a downwardly configuration, they fail to focus light directly on the flag. Such devices illuminate the entire area around the pole, even though the flag is only on one side of the pole at any given time.

Other configurations have been utilized which place lighting devices with light sources adjacent to the flag. For example, U.S. Pat. No. 1,171,917 discloses the arrangement of several light sources adjacent to the hoist or staff end of the flag. Correspondingly, U.S. Patent Application Publication No. 2003/0193804 proposes the placement of a light source within a transparent portion of the pole, immediately adjacent the flag. Both of these designs use reflectors which focus light directly toward the flag, and/or are adapted to pivot around the pole in a proper relationship to the flag, as the flag changes positions due to directional changes in airflow. Although these foregoing devices provide some advantages in that they illuminate the flag and are capable of maintaining illumination as wind causes the flag to rotate around the pole, such devices are not adaptable to existing poles.

In contrast, and with reference to the numerical references in the drawings of the Lawrence et al. patent, a flagpole beacon 10 is provided for a pole mounted flag. The beacon 10 includes a light source 20 and cover 30. The cover 30 has at least one opening 40 through which light can pass. The opening 40 of the cover 30 is positioned so that light from the source 20 is focused directly on the flag. The cover 30 can be shaped so as to form a ball having an appropriate diameter, depending upon the flag and flagpole size. The beacon can include the use of bulbs, LEDs and the like. The opening 40 of the cover 30 may either be a void or may contain a lens 80. The beacon 10 can also include a truck 50 for allowing the cover 30 to rotate. The truck 50 is connected to the cover 30 and to the top of the pole. Also, the pole beacon 10 includes a pulley 60 through which the halyard passes. The pulley 60 is operationally associated with the truck 50 and the cover 30, so that when the flag responds to a change in wind direction, the pulley 60 and the cover 30 rotate about the pole with the flag, and cause light to be continuously directed from the source 20 toward the flag. Advantageously, the beacon 10 can be utilized with a fitting 70 so as to replace the typical separate knob portion of an existing pole, with a means for illuminating the flag.

Another flag or banner utilizing a lighting system is disclosed in Barnhouse et al., U.S. Patent Application Publication No. 2007/0089338 published Apr. 26, 2007. Specifically, Barnhouse et al., with reference to the numerical references in their drawings, disclose a lighted pole and banner assembly 100 having a support 110, light source 120, conductor 130, connector 140, cap 150 and banner 200. The support 110 can be illuminated at night, and may be manufactured from a clear acrylic or other transparent materials. The support can also have non-uniform light transmitting characteristics. The support 110 can be configured as a hollow tube receiving the light source 120 therein. Various dimensions of light and banner systems are also disclosed.

The support 110 includes a first end 112 and second end 114. The first end 112 can be equipped with a cap 150 for decoration. The cap 150 can also act as a barrier, so that the light source 120 cannot escape from the support 110, and also to protect the light source 120 from weather. The light source 120 can include a first end 122 and second end 124, with a series of filaments 126 disposed therebetween. The first end 122 includes a coupler configured for coupling the light source 120 to a conductor 130, while the second end comprises a point of termination, where the filaments 126 conclude.

Various other concepts associated with light sources and flagpoles are disclosed. For example, the light source 120 can include a rope light for maintaining the filaments 126. A variety of colors can be utilized with the light source 120. Also, the brightness of the light source 120 can be varied according to the height along the support 110.

The light source 120 can be located within a support 110, but also can be modified so that the support 110 can receive the light source 120 on any portion of the support 110.

An alternative embodiment includes a portable lighted wand for supporting the banner. A handle 800 includes finger grips for receiving a user's fingers, and a switch 820 is disposed on the handle 800. The switch 820 can control the brightness and general illumination of the filaments.

Barnhouse et al. also disclose the use of the illumination with flags mounted on hats, poles with lighted animation, belts and LED displays.

Garrett, U.S. Design Pat. No. D535,584 issued Jan. 23, 2007 illustrates a flagpole having an illuminating light fixture assembly in the form of a detachable and spherically-shaped cap.

Topps, U.S. Patent Application Publication No. 2007/0035956, published Feb. 15, 2007, describes a lighted rod assembly, with a method for use thereof. Specifically, the lighted rod assembly is adapted for mounting on a vehicle, including such vehicle devices as bicycles, motorcycles, wheelchairs, scooters and the like. The assembly includes a power supply line which extends along the rod. A series of electrical light sources are spaced along the length of the rod. The sources are in a power supply communication with the power supply line. A power source is attachable to the power supply line so as to energize the light sources. In this manner, the rod is illuminated. A flag can be mounted on the rod so as to increase the visibility of the assembly.

More specifically, and with reference to the numerical references and the drawings of the patent application publication, the publication discloses a lighted rod assembly apparatus 100. The assembly includes an elongated and generally cylindrical rod 110, with a power supply harness 120. The power supply harness 120 can include one or more pairs of electrically conducted wires, which are mounted within an internal, axially extending passage in the rod assembly 100. The wires may be plastic coated or otherwise bare. A series of light emitting sources 124 are also provided. The sources 124 can be in the form of flashlight lamps, small light bulbs, fuse lights, LEDs, or other similar light sources. The light sources 124 can be soldered to the power supply harness 120 or otherwise fixed to the harness with electrical connectors. A flag 126 can be attached to the rod assembly 100 at any convenient location. A power source 128 can be provided for the light sources 124. The power source 128 can be mounted to the bottom end of the rod 120, opposing the flag 126, and can include batteries or a generator. Also, the rod 100 can be in the form of multiple rod sections.

Another flagpole device incorporating a lamp is disclosed in U.S. Pat. No. 4,274,127. Therein, the disclosure includes an elongated pole mounted to a bicycle, with a lamp housing mounted to the upper end of the pole. A rod has optical properties and extends upwardly from the lamp housing. The '127 patent discloses the use of only one light source, at the upper end of the rod. Such a single light source, and associated illuminated structure, can be relatively difficult to locate as being at a particular distance from, or moving in a particular direction with respect to a remote observer. This problem is exacerbated in very low or no light conditions.

Another known device is disclosed in Racoosin, U.S. Patent Application Publication No. 2006/0023446, published Feb. 2, 2006. Racoosin discloses a solar lighting system for use with a flag. The lighting system includes a lighting element, and a housing adapted to receive the lighting element. A mounting element is provided which is adapted to mount the housing on the flag, and a power source is provided for providing electrical power to the lighting element. The housing substantially transmits light produced by the lighting element. The power source disclosed in Racoosin includes a combination solar panel and battery, with the entirety of the source being adapted for connection to the lighting element.

Racoosin also discloses the concept of having the flag consist of a piece of cloth with a lighting element positioned within the cloth. The lighting element produces light, and includes multiple spaced apart lighting strips arranged substantially in parallel. More specifically, and with reference to the drawings and the numerical references in the application publication, a flag 10 includes a flag body 10A and a lighting element 16 configured to produce light. The lighting element 16 is powered by a power source 24, with the power source 24 having solar panels 40. In one embodiment, a lighting system 12 is provided which is mounted to the elongated outer edge 11 of the flag 10. The mounting element includes a housing 14, which functions to contain the lighting element 16. The flag 10 is positioned under a top of a flagpole 20, adjacent a truck assembly 18, and is attached to a halyard 22, for purposes of raising and lowering the flag 10 on the flagpole 20.

In a separate embodiment, a flag 70 includes a piece of cloth 72 with a lighting element 74 disposed therein. The mounting element is provided by the piece of cloth 72 itself, as the element 74 is woven or otherwise integrated into the flag 70. The lighting element 74 includes multiple spaced apart lighting strips 76, with the strips 76 preferably arranged substantially in parallel. The lighting strips may, for example, be woven into the piece of cloth 72.

A further illuminated flagpole element is disclosed in Mueller, U.S. Patent Application Publication No. 2004/0083633, published May 6, 2004. With reference to the numerical references in the Mueller publication, a lighted pole and banner assembly 10 consists of a support 110, light source 120, conductor 130, connector 140, cap 150, and banner 200. The support 110 is illuminated at night so that the flag is properly illuminated. Also, the support may have non-uniform light transmitting characteristics, with the light passing through at least portions of the support 110. The light source can be configured so as to be located within a hollow portion of the support 110, and may enter the support 110 through a second end 114. The light source 120 can include a first end 122 and second end 124, with a series of filaments 126 disposed therebetween. The first end 122 can include a coupler configured for coupling the light source 120 to the conductor 130, while the second end 124 consists of a point of termination, where the filaments 126 conclude.

A general disclosure of a flagpole and flag associated therewith is set forth in Campbell, et al, U.S. Patent Application Publication No. 2006/0065182, published Mar. 30, 2006. In the application publication, a method and device for preventing a flag from furling is disclosed. The device includes a fastener for attaching a device to a flag, and an elongated tensile element having a first end attached to the fastener, and a second end. A weighted object is attached to the second end of the tensile element. The method associated with the publication includes fastening a first end of an elongated tensile element to a flag, and attaching a weighted object to the second end of the elongated tensile element. The elongated tensile element can include a rigid element, such as a rod or bar, or a pliable element. The interaction of the elongated tensile element and the weighted object counteracts flag motion which tends to furl the flag around the flagpole. The weighted object can include a support structure, and a source of illumination for the flag.

With respect to illumination, the application publication discloses an illumination device having a fastener for attaching the device to the flag. An elongated tensile element having a first end is attached to the fastener and to the second end. A source of illumination is attached to the second end of the tensile element. Disclosure is made of the use of a fluorescent light, an incandescent light, or an LED. Also, the device can include a source of illumination support bracket.

In addition, the application publication discloses a method for illuminating the flag. The method includes fastening a first end of an elongated tensile element to the flag. A source of illumination is attached to a second end, and is directed toward the flag. The method further includes attaching the source of illumination by mounting the source of illumination to a support structure, and mounting the support structure to the second end of the elongated tensile element.

### BRIEF SUMMARY OF THE INVENTION

In accordance with the invention, a universal solar illuminator system is provided, for displaying a flag or banner, and selectively illuminating the flag or banner as desired by the user. The universal solar illuminator system can be adapted to an existing flagpole, whether the pole is positioned in a vertical, horizontal or angular orientation.

In one embodiment of the invention, the universal solar illuminator system can be mounted to a flagpole apparatus having a flag mounted thereto. The illuminator system can comprise a series of illumination elements having a plurality of LED lights. The universal solar illuminator system can be mounted in any orientation, as desired by the user. The LED lights can be electrically connected to a circuit board conductively connected to the LED lights. The electrical lines can be connected in a series configuration, a parallel configuration or combination of the same.

Also connected to the circuit board as an incoming power source is a battery pack. The battery pack provides for an independent source of power, and can apply the power to the electrical lines associated with the LED lights through the circuit board. The universal solar illuminator system can also include one or more solar panels which can be positioned in a longitudinal configuration along the universal solar illuminator. As with the battery pack, the solar panels can include electrical conductors running from the solar panels to the circuit board. The electrical conductors essentially conduct electrical power collected by the solar panels, and can transmit the same to the battery pack through the electrical lines associated with the battery pack and the circuit board. The conductors and other circuit elements on the circuit board can not only direct electrical energy collected from the solar panels to the battery pack, but also direct power from the battery pack to the LED lights. Conventional switching elements can also be provided on the circuit board for selectively enabling and disabling the application of power to the LED lights.

In addition to the foregoing, the universal solar illuminator system can include a reflection shield which can be built into the universal solar illuminator system by the LED lights in a direction which illuminates the flag or banner which is connected to the universal solar illuminator. If desired, the universal solar illuminator system in accordance with the invention can also include the use of connection hooks for connecting the flag or banner and universal solar illuminator assembly to the flagpole itself. Still further, the mechanical configuration of the solar illuminator system associated with the flagpole includes means for appropriately interconnecting the illuminator to a conventional flagpole, so that the illuminator will appropriately rotate in correspondence with the rotation of the flag or banner about the flagpole. In this manner, illumination of the flagpole or banner is maintained independent of the speed or direction of angular rotation of the flag or banner.

Further in accordance with the invention, the universal solar illuminator system is adapted to be mounted to a flagpole apparatus having a flagpole and flag. The illuminator system includes an elongated structure in the form of a cylindrical shell opening outwardly and exposing a recessed area with a rear curved surface. An LED network includes a series of LED's disposed in a vertical configuration, with the recessed area formed in front of the LED's.

The system also includes a DC circuit, along with a pair of solar panels. A battery pack is also included, with the solar panels charging the battery pack during daylight conditions. The battery pack energizes the LED's through the DC circuit during nighttime conditions.

### BRIEF DESCRIPTION OF THE SEVERAL VIEWS OF THE DRAWING

FIG. 1 is a front, perspective view of a universal solar illuminator system in accordance with the invention, as applied to a flagpole apparatus;

FIG. 2 is a side, elevation view of the universal solar illuminator system illustrated in FIG. 1;

FIG. 3 is a plan, sectional view of the universal solar illuminator system shown in FIG. 1;

FIG. 4 is a front, elevation view of a second embodiment of the universal solar illuminator system in accordance with the invention, as applied to the entirety of a flagpole system;

FIG. 5 is a third embodiment in a front, elevation view of a universal solar illuminator system in accordance with the invention, again as applied to a flagpole system; and

FIG. 6 is a fourth embodiment of a universal solar illuminator system in accordance with the invention, as applied to a flagpole system and using individual, compartmentalized LED's, battery packs and solar panels.

### DETAILED DESCRIPTION OF THE INVENTION

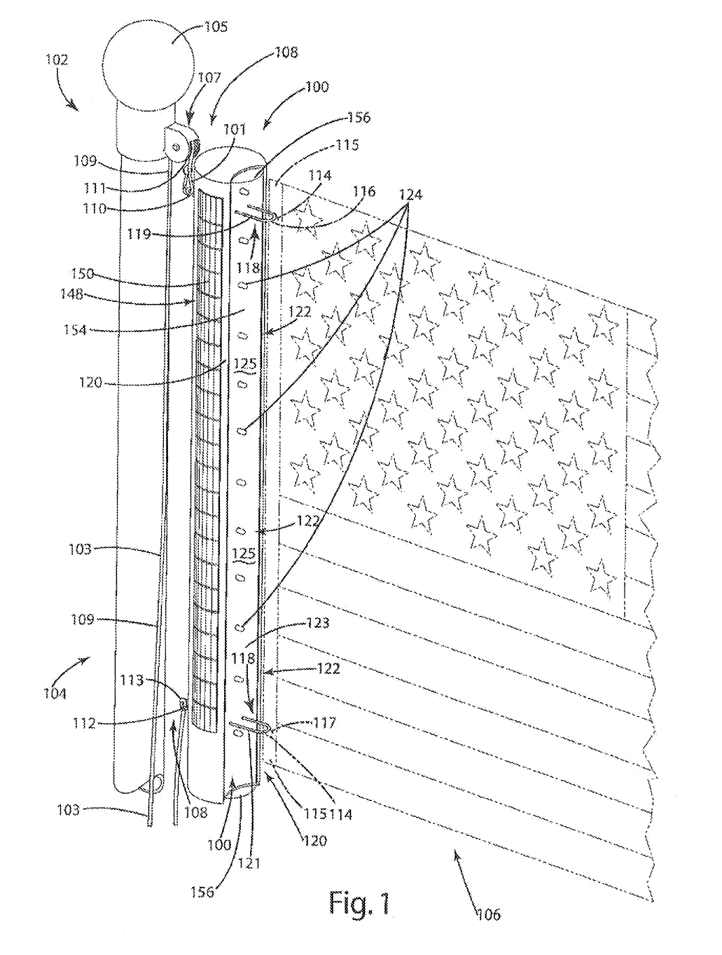

The principles of the invention are disclosed, by way of example, in embodiments of universal solar illuminator systems as illustrated in FIGS. 1-6, including universal solar illuminator system 100 disclosed herein and illustrated in FIGS. 1-3. As will be made apparent from the description herein, the universal solar illuminator system 100 and other embodiments described herein operate as standalone devices, and may be adapted for selectively illuminating a flag or a banner as desired by the user. The universal solar illuminator systems can be adapted so as to be retrofitted to any existing flagpole apparatus, independent of whether the pole of the flagpole is positioned in a vertical, horizontal or angular orientation.

Turning specifically to FIGS. 1-3, the universal solar illuminator system 100 is illustrated as being adapted for use with a flagpole apparatus 102. The flagpole apparatus 102 can be conventional in structure and can be any of numerous types of flagpole apparatus. The flagpole apparatus 102 can include a conventional flagpole 104, having a conventional flagpole globe 105 mounted at the top thereof. The flagpole 104 can be mounted vertically, horizontally or in an angular configuration, while still capable of use with universal solar illuminator systems in accordance with the invention. The flagpole apparatus 102 further includes a conventional flag 106. For purposes of mounting the universal solar illuminator 100 and the flag 106 to the flagpole 104, a pulley device 107 is formed below and on one side of the flagpole globe 105. Rotatably secured around the pulley device 107 is a conventional flagpole rope 109. As particularly shown in FIG. 1, the flagpole rope 109 has one section 103 which extends around one side of the pulley device 107 and thereafter extends downwardly toward a ground or other support level where a flagpole user may have manual access to the rope 109 for purposes of raising and lowering the flag 106. One end of the flagpole rope 109, referred to herein as a first rope terminating end 111, is looped around the other side of the pulley device 107 and is tied to a releasable clip 101. An opposing terminating end of the rope 109, referred to herein as a second rope terminating end 113, is contiguous with the rope section 103. The releasable clip 101 and the second rope terminating end 113 are releasably coupled to inner attachment hooks 108. As further shown in FIG. 1, the inner attachment hooks 108 can comprise an upper attachment hook 110 which is secured in any suitable manner to the universal solar illuminator 100, and also releasably secured to the releasable clip 101. The inner attachment hooks 108 also include a lower attachment hook 112, again as shown in FIG. 1. The second rope terminating end 113 can be directly tied to the lower attachment hook 112 or, alternatively, can be coupled to the hook 112 through connecting means such as the releasable clip 101.

It should be emphasized that the particular configuration of the flagpole apparatus 102, including the flagpole 104, globe 105, pulley device 107, and flagpole rope 109 can take any of a number of different configurations. Also, components other than the releasable clip 101, inner attachment hooks 108, and flagpole rope 109 can be utilized for purposes of attaching the universal solar illuminator 100 to the flagpole apparatus 102, without departing from the principal concepts of the invention. In fact, various other types of connection and attachment means are illustrated and described with respect to additional embodiments as set forth in subsequent paragraphs herein.

Continuing to refer primarily to FIG. 1, the flag 106 can be a conventional flag. On one side of the flag 106 (commonly referred to as the “left side” and shown, for example, on the left side of the flag illustrated in FIG. 1), a set of at least two eyeholes 114 extended through a left side seam 115. As further shown in FIG. 1, the eyeholes 114 include an upper eyehole 116 and a lower eyehole 117. It should be noted that for purposes of illustration and description, the flag 106, including the left side seam 115 and eyeholes 114, are all shown in phantom-line format in FIG. 1.

The eyeholes 114 are provided for purposes of achieving a releasable connection between the solar illuminator 100 and the flag 106. Specifically, a pair of outer attachment hooks 118 extend outwardly from one side of the solar illuminator 100 as expressly shown in FIG. 1. The outer attachment hooks 118 can comprise an upper attachment hook 119 and a lower attachment hook 121. The outer attachment hooks 118 can be any of a number of different types of connection means, and can be in the form of a U-shaped hook which is capable of being opened in any physical manner so as to be received through one of the corresponding eyeholes 114. The outer attachments 118 can also be fixedly secured to the universal solar illuminator 100 in any suitable manner. Still further, if desired, the outer attachment hooks 118 can also be integral with or otherwise part of corresponding ones of the inner attachment hooks 108. That is, the upper attachment hook 110 and the upper attachment hook 119 can actually be one hook, extending through the body of the solar illuminator 100. Correspondingly, the lower attachment hook 112 and the lower attachment hook 121 can also be formed as a single structure.

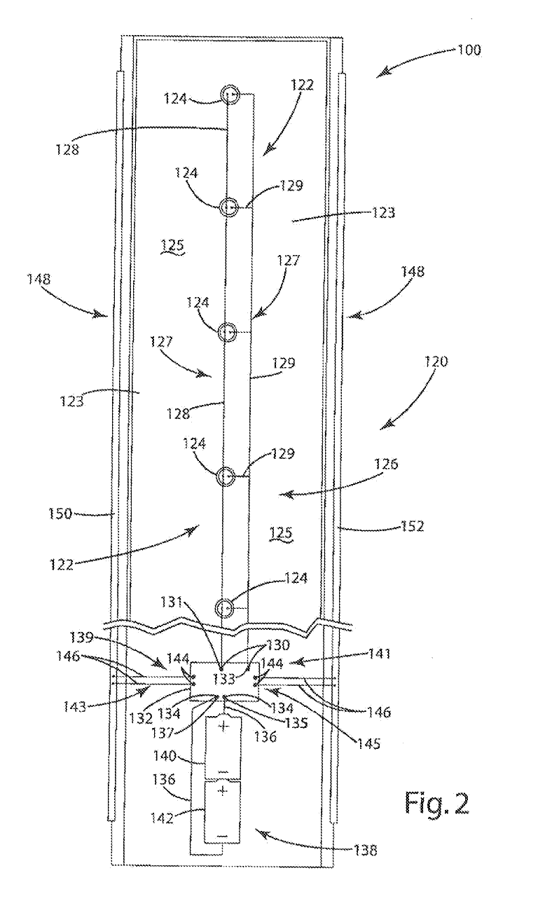

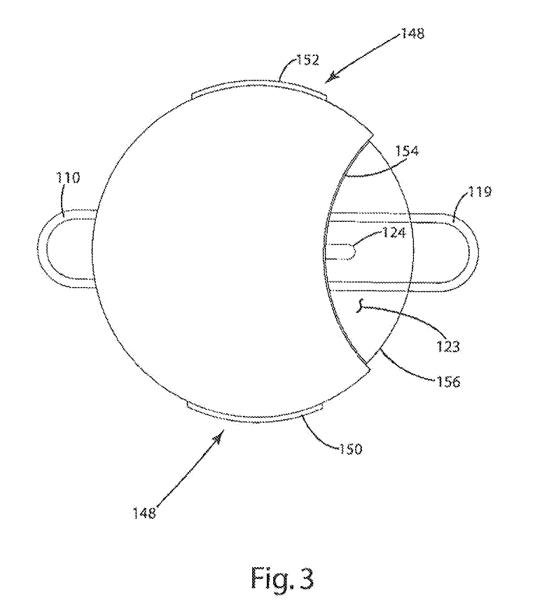

The universal solar illuminator system 100 itself will now be described in greater detail, with respect to FIGS. 1, 2 and 3. While FIG. 1 illustrates a perspective view of the illuminator system 100, FIG. 2 illustrates the system in a stand-alone configuration, and FIG. 3 illustrates a plan view (again, in a stand-alone version) of the illuminator systems 100. With reference to these drawings, the system 100 includes an elongated structure 120 in the form of a partial cylindrical shell. The elongated structure or cylindrical shell 120, as primarily shown in FIGS. 1 and 3, opens outwardly and exposes a recessed area 123 having a rear curved surface 125. This rear curved surface 125 can be in the form of a reflection shield 154, utilized to provide greater intensity to the illumination capacity of the illuminator system 100, without requiring additional power requirements, high LED intensities or the like. It should be noted that this reflection shield 154 can be optional and provided as a separate component or, alternatively, can be integrally incorporated within the solar illuminator system 100, so as to be a part thereof. In any event, and if desired in accordance with certain concepts of the invention, the curved surface 125 or reflection shield 154 may be parabolic in structure. With a parabolic configuration, the LED's 124 (discussed in subsequent paragraphs herein) will emit light which is subjected to an optimum reflectivity with respect to illumination. That is, with a parabolic reflective surface (which is readily available as a commercial product), light from a point light source positioned at the center focal point of the parabolic surface will have its light energy reflect off the surface in directions which are parallel to the central axis of the surface. This will essentially cause the light reflected from the point source to have optimum intensity in the direction of the light rays.

Incorporated within the elongated structure 120 of the solar illuminator system 100 is an LED network 126. Components of the LED network 126 are primarily shown in FIG. 2. With continued reference to FIG. 2, the LED network 126 is shown as comprising an LED array 122 disposed within the recessed area 123. The LED array 122 is shown as having a series of LED's 124 disposed in a vertical configuration. Although shown in a vertical configuration, it should be emphasized that illuminator systems in accordance with the invention can include any number of geometric configurations of LED arrays and associated LED's. Further, although FIG. 2 shows the use of four LED's 124, this representation is only symbolic and any number of LED's can be utilized, dependent upon power capabilities and the level of light intensity desired by the user.

As earlier stated, the elongated structure 120 opens outwardly on one side and a recessed area 123 is formed in front of the reflection shield 154 and LEDs 124. This area 123 can be enclosed by a transparent cover 156 as shown in FIGS. 1 and 3. As also shown, the cover 156 (which protects the shield 154 and LEDs 124 from environmental conditions) may be in the form of a curved surface which matches the curvature of the outside surface of the structure 120.

The LED's 124 are shown as being energized through the use of a DC (for direct current) circuit 127. The DC circuit 127 essentially consists of the LED's 124 connected in a parallel configuration through a two-wire circuit. The DC circuit 127 comprises a first or hot conductive wire 128, and a ground, neutral or “return” conductive wire 129. The hot conductor 128 and the return conductor 129 are each attached to separate LED terminals 130 which are mounted on a circuit board 132. The LED terminals 130 include a hot terminal 131 connected to the first or hot conductor 128, and a neutral, ground or return terminal 133 connected to the return conductor 129. The voltage across the two LED terminals 130 will substantially correspond to the voltage applied to each of the LED's 124 (ignoring any voltage drop as the result of inherit resistance associated with the conductors 128, 129, which would be minimal). The particular voltage applied across the two LED terminals 130 can be varied through circuitry on the circuit board 132, and can be made dependent upon the particular power ratings for the LED's used as the LED's 124. Such circuitry and the general concepts associated with LED power ratings are well known in the prior art. For example, conventional and commercially available LED's may operate at ratings of 3, 6, 10 or 12 volts. For the DC circuit 127, it should be emphasized that the conductors 128 and 129 can be in the form of wires, cables, conduit or any appropriate means of electrical conduction.

The circuit board 132, in addition to carrying the LED terminals 130, also includes a pair of battery terminals 134. As expressly shown in FIG. 2, the battery terminals 134 can comprise a hot or positive terminal 135 and a neutral or ground terminal 137. The battery terminals 134 are connected through a pair of battery cables 136 to a series battery pack 138. The series battery pack 138 can include one or more batteries, such as the first battery 140 and second battery 142 illustrated in FIG. 2 as being part of the battery pack. The circuit board 132 operates so as to provide for conductive connections between the battery terminals 134 and the LED terminals 130 when in a night time or other darkened environment. In this manner, the LED network 126 is powered through the series battery pack 138. More specifically, the hot or positive terminal 135 can be conductively connected to the hot terminal 131 on the circuit board 132 when power is being supplied from the battery pack 138. Correspondingly, the negative or ground terminal 137 can be conductively connected to the ground or return terminal 133. The circuit board 132 can also include appropriate switching circuitry so as to enable and disable the conductive connections between the battery terminals 134 and the LED terminals 130. In addition, such circuitry can also include appropriate voltage regulation circuitry so as to ensure that the voltages being applied to the LED's 124 are within appropriate specifications. Electrical circuit elements to perform the functions described herein for the circuit board 132 are well known to those of ordinary skill in the electrical circuit design arts, and the components to perform the appropriate functions are well known and commercially available.

In addition to carrying the LED terminals 130, battery terminals 134 and circuitry for switching electrical configurations so as to provide conductive connections between the series battery pack 138 and the LED terminals 130 during night time or other darkened conditions, the circuit board 132 also carries pairs of solar panel terminals 144. In the particular embodiment shown in FIG. 2, two pairs of solar panel terminals 144 are provided. The pairs of solar panel terminals 144 are identified in FIG. 2 as comprising a first solar panel terminal pair 139 and a second solar panel terminal pair 141. Each pair of solar panel terminals 144 is connected to a corresponding pair of solar panel conductors 146. The solar panel conductors 146 can be any type of suitable conductive elements, such as wires, cables, conduit or the like. In FIG. 2, one pair of the solar panel conductors 146 is identified as a first solar panel conductive pair 143, connected to the first solar panel terminal pair 139. Correspondingly, the other pair of solar panel conductors 146 is identified as a second solar panel conductor pair 145 connected to the corresponding second solar panel terminal pair 141.

Each pair of solar panel conductors 146 is connected, in a conventional manner, to a solar panel array 148. The solar panel array 148 can consist of one or more commercially available solar panels which can be utilized to collect electrical energy from sunlight. In fact, with many commercially available solar panels, electrical energy can be collected not only from sunlight, but from other light sources. Without departing from the principal concepts of the invention, any number of solar panels may be utilized with the solar panel array 148. For example, FIG. 2 illustrates the use of a first solar panel 150 and a second solar panel 152. The first solar panel 150 is shown as being conductively connected to the first solar panel conductor pair 143. Correspondingly, the second solar panel 152 is shown as being conductively connected to the second solar panel conductor pair 145. The means for attaching conductive elements such as the solar panel conductors 146 to the circuit board 132 and to the solar panel array 148 are conventional and well known in the art of solar panel circuit design. Solar panels which may be utilized with embodiments in accordance with the invention include panels manufactured by Outside Supply LLC of New Orleans, La.

As earlier stated, the circuit board 132 preferably includes circuitry which provides for selectively switchable interconnections between the series battery pack 138 and the LED network 126, so as to provide a conductive connection therebetween in night time or other darkened conditions, for purposes of energizing the LED's 124. Correspondingly, the circuit board 132 also preferably includes selectively switchable circuitry which conductively connects the solar panel terminals 144 to the battery terminals 134 in day time or other conditions when the solar panel array 148 is collecting electrical energy from the external environment. With this interconnection, and with appropriate circuitry associated with the circuit board 132, the solar panel array 148 is energizing or otherwise “charging” the batteries 140, 142, during these daylight conditions. In this manner, the LED's 124 can be activated so as to illuminate the flag 106 in a desired manner. Still further, if it would be desired for any reason, the pairs of solar panel terminals 144 could also be selectively switched on the circuit board 132, in a manner so as to provide for an electrical connection between the solar panel array 148 and the LED terminals 130, independent of connections to the battery pack 138. If such connections were desired, additional voltage regulation circuitry may be required for the circuit board 132.

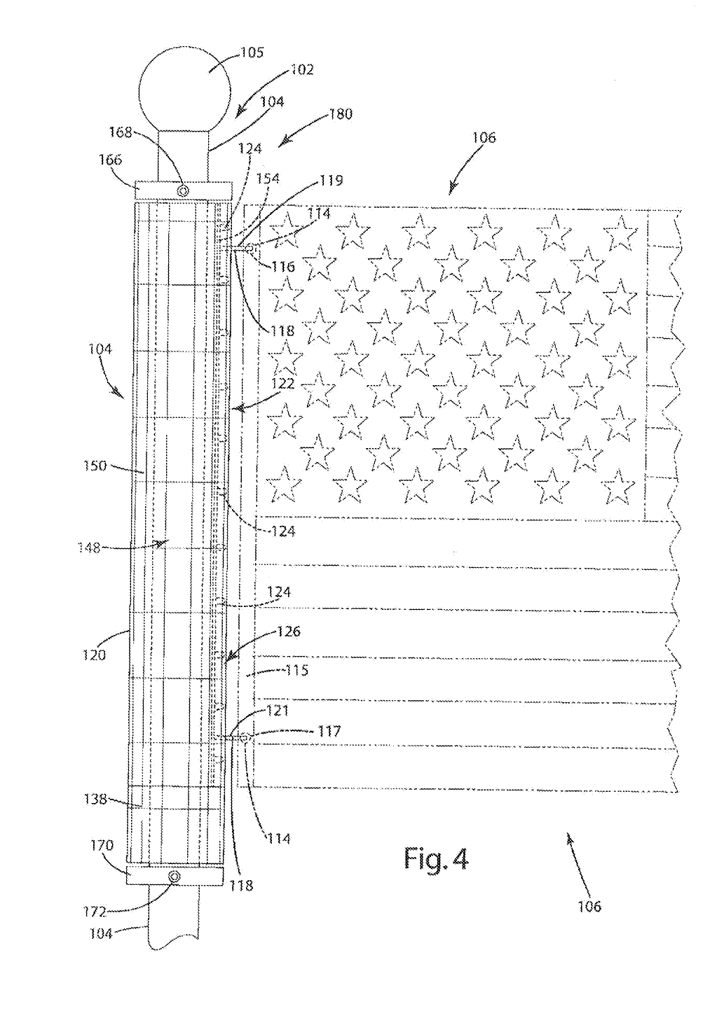

As earlier stated, various other embodiments of universal solar illuminators in accordance with the invention can be developed and utilized, without departing from the principal concepts of the invention. For example, with reference back to FIGS. 1, 2 and 3, the universal solar illuminator 100 is shown as being positioned adjacent the flag pole 104. In FIG. 4, the solar illuminator in accordance with the invention is illustrated as universal solar illuminator 180. The solar illuminator 180 includes substantially all of the electrical and solar components as incorporated within the universal solar illuminator 100, and detailed descriptions of these components will not be repeated herein. The principal distinction between the universal solar illuminator 180 and the solar illuminator 100 previously described herein is that the solar illuminator 180 is adapted to essentially “fit around” the flagpole 104. In contrast, and as previously described herein, the solar illuminator 100 is positioned adjacent the flagpole 104.

With further reference to the solar illuminator 180 as shown in FIG. 4, the illuminator is shown with a flagpole apparatus 102 having a flagpole 104 with an upper globe 105. In the particular embodiment in FIG. 4, the rope apparatus (shown with the solar illuminator 100 as comprising flagpole rope 109 and pulley device 107, along with upper and lower attachment hooks 110, 112, respectively) has been omitted. In addition to the flagpole 104, the universal solar illuminator 180 is shown as being used with the flag 106, having eyeholes 114 extending through a left side seam 115. The eyeholes include an upper eyehole 116 and lower eyehole 117. Also, FIG. 4 shows the use of outer attachment hooks 118 connecting the flag 106 to the solar illuminator 180. The attachment hooks 118 include an upper attachment hook 119 and lower attachment hook 121. These attachment hooks 118 attach to the solar illuminator 180 along the elongated structure or housing 120.

With respect to the solar illuminator 180 itself, the illuminator can also include the LED array 122 having a series of LED's 124 as part of an LED network 126. Although not shown, the LED network 126 would include a DC circuit corresponding to the DC circuit 127 shown with respect to the solar illuminator 100.

The solar illuminator 180 would also include a battery pack 138 at the lower portion thereof. In addition, the illuminator system 180 can also include a solar panel array 148 comprising a first solar panel 150 and a second solar panel (not shown in FIG. 4). In addition, a reflection shield (not shown) can be incorporated within the illuminator system 180.

The illuminator system 180 will electrically operate in the same manner as the previously described illuminator system 100. However, in addition to the electrical elements and the elongated structure 120 which provides a housing which surrounds the flagpole 104, the embodiment shown in FIG. 4 includes a pair of lock rings comprising an upper lock ring 166 and lower lock ring 170. Each of the lock rings 166, 170 are annular structures which surround and are secured to the flagpole 104 through an upper set screw 168 and lower set screw 172. The lock rings 166 and 170 provide a releasable means for positioning the solar illuminator system 180 at a desired height or other relative location along the flagpole 104. Further, with the configuration shown in FIG. 4, the solar illuminator 180 can be configured so as to freely rotate relative to the circumferential surface of the flagpole 104. In this manner, the flag 106 is free to be positioned by wind or other air currents so as to unfurl in an optimum manner.

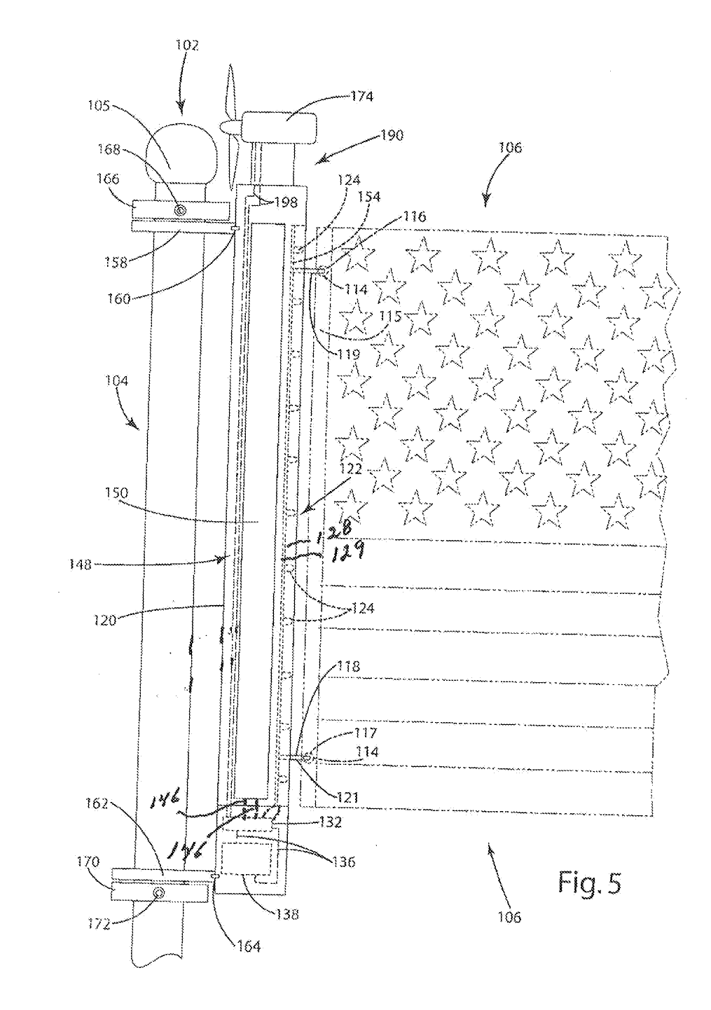

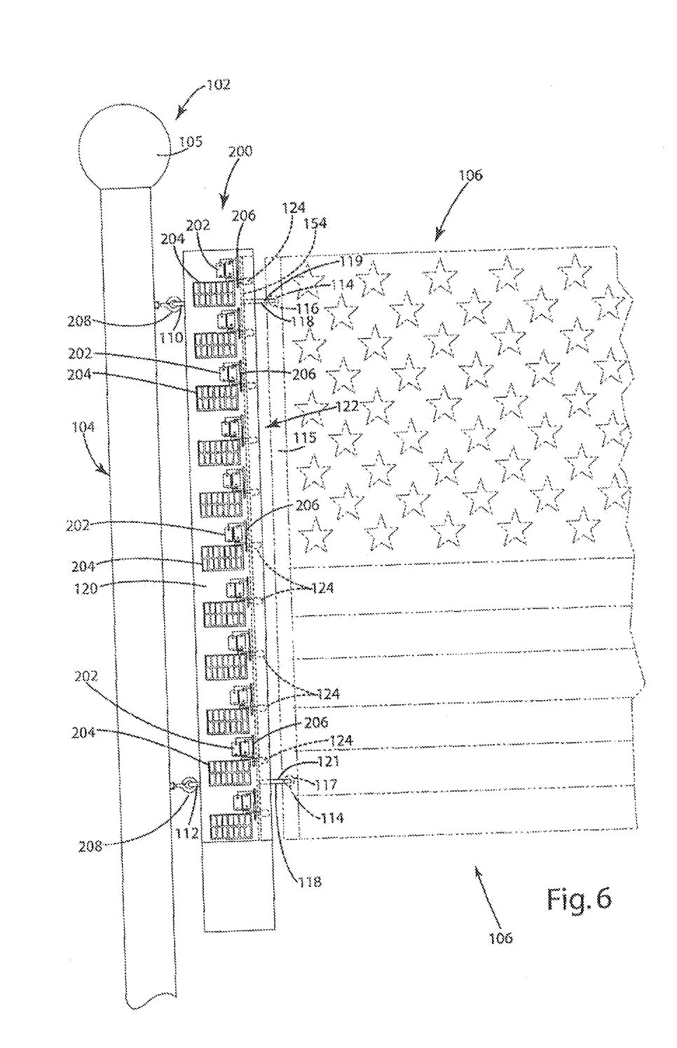

A further embodiment of an illuminator system in accordance with the invention is illustrated in FIG. 5, and identified as universal solar illuminator 190. As with the previously described universal solar illuminator 100, the universal solar illuminator 190 is positioned adjacent to the flagpole 104. Also, as with the embodiments comprising the solar illuminator 100 and solar illuminator 180, the solar illuminator 190 comprises electrical components common to each of the illuminator embodiments described herein and illustrated in FIGS. 1-4. As discussed in subsequent paragraphs herein, a further embodiment illustrated in FIG. 6 has a slightly different configuration.

With respect to FIG. 5 and the solar illuminator 190, the elements shown in the drawing and common to either the illuminator embodiment 100 or the illuminator embodiment 180 will not be described in any substantial detail, in that they have been described in detail in the prior paragraphs. These elements include the flagpole apparatus 102 comprising the flagpole 104 and globe 105. The illuminator 190 is attached to the flag 106. As with the illuminator 180 described with respect to FIG. 4, the illuminator 190 does not include any type of rope apparatus.

Regarding the flag 106 shown in FIG. 5, the flag includes eyeholes 114 positioned in a left-side seam 115. The eyeholes 114 comprise an upper eyehole 116 and lower eyehole 117. Outer attachment hooks 118 coupled to the illuminator 190 extend outwardly and connect through the eyeholes 114. The attachment hooks 118 include an upper attachment hook 119 and lower attachment hook 121.

The solar illuminator 190 includes an elongated structure 120 with an LED array 122 comprising a series of LED's 124. The electrical circuit configuration associated with the illuminator 190 includes a circuit board 132 and a battery pack 138. The LED's 124 again are energized through conductive wires 128, 129 connected to circuit board 132. A solar panel array 148 is also provided, with a first solar panel 150 and a second solar panel (not shown in FIG. 5) on a side of the housing 120 opposing the side to which the first solar panel 150 is attached. The solar panel 150 is connected to the circuit board 132 through conductors 146. The circuit board 132 is connected to the battery pack 138 through conductors 136. The solar panel array 148, LED array 122, circuit board 132 and battery pack 138 have the same structure and functions as like-numbered elements previously described with respect to FIG. 2. However, these elements in system 190 also function with a wind turbine 174 as described in subsequent paragraphs herein.

Specific with respect to the embodiment 190 shown in FIG. 5, the embodiment includes a pair of annuli which surround the flagpole 104 and are sized and configured so as to be rotatable relative to the flagpole 104. The annuli comprise an upper annulus 158 and a lower annulus 162. The upper annulus 158 is connected to the solar illuminator system 190 through an upper eye clip 160. Correspondingly, the lower annulus 162 is connected at the bottom portion of the solar illuminator system 190 through a lower eye clip 164. The solar illuminator system 190 and the flagpole apparatus 102 shown in FIG. 5 also include a pair of lock rings, comprising an upper lock ring 166 and lower lock ring 170. Each of the lock rings 166, 170 are annular structures which surround and are rigidly, but releasably secured to the flagpole 104 through an upper set screw 168 (for the upper lock ring 166) and a lower set screw 172 (for the lower lock ring 170).

In addition to the foregoing elements, and in contrast to the solar illuminator embodiments 100 and 180, the universal solar illuminator system 190 can include the relatively small wind turbine 174, for purposes of generating electrical energy in response to energy collected by the turbine 174 from wind currents. The wind turbine 174 can be any of a number of well known and commercially available wind turbines used to generate electricity. As shown specifically in FIG. 5, the wind turbine 174 can be mounted at the top portion of the solar illuminator system 190 in any suitable manner. In a somewhat “symbolic” format, FIG. 5 also illustrates a pair of electrical conductors 198 extending downwardly from the wind turbine 174 to the circuit board 132 shown as being mounted at the lower portion of the illuminator 190. With this configuration, the wind turbine 174 operates so as to generate electrical energy and apply corresponding charging currents to the battery pack 138 through the circuit board 132. Appropriate switching elements can be included with the circuit board 132 or elsewhere on the illuminator 190 so as to selectively enable and disable the application of charging current to the battery pack 138 from the turbine 174 through the circuit board 132. The wind turbine 174 can be utilized to provide for what can be characterized as “back up” battery charging current, in the event of relatively low solar power, resulting from cloudy or other from inclement weather conditions and the like. Also, the wind turbine 174 can be utilized to provide charging power to the battery pack 138 during night time hours, when the solar panels 148 are not collecting solar energy.

A still further embodiment of a solar illuminator system in accordance with the invention is illustrated in FIG. 6, and identified as universal solar illuminator 200. As shown in FIG. 6, the solar illuminator system 200 is positioned adjacent to the flagpole 104, in a manner similar to the illuminator system embodiment 100 and the illuminator system embodiment 190. A number of the mechanical and electrical elements of the solar illuminator system 200 substantially correspond to elements shown in the embodiments of FIGS. 1-5. Accordingly, detailed descriptions of these elements will not be repeated herein.

With respect to elements of the solar illuminator system 200 comparable to those of other embodiments described herein, the illuminator system 200 includes a flagpole apparatus 102 having a flagpole 104 and globe 105. A flag 106 is also provided, and is coupled to the solar illuminator system 200. To secure the illuminator system 200 to the flagpole 104, an upper attachment hook 110 is secured to an elongated housing or structure 120 of the illuminator system 200 at the upper portion thereof. Correspondingly, a lower attachment hook 112 is also secured to the elongated structure 120, but at a lower portion thereof. An upper eyehook 208 secured to the flagpole 104 can be releasably received within the upper attachment hook 110. Correspondingly, a lower eyehook 208 secured at a relatively lower location to the flagpole 104 is releasably secured to the lower attachment hook 112.

For purposes of releasably securing the solar illuminator system 200 to the flag 106, the flag 106 includes a pair of eyeholes 114 positioned in the left-side seam 115 of the flag 106. The eyeholes 114 include an upper eyehole 116 and lower eyehole 117. The solar illuminator system 200 includes a pair of outer attachment hooks 118, comprising an upper attachment hook 119 and lower attachment hook 121. The upper attachment hook 119 is releasably secured to the upper eyehole 116, while the lower attachment hook 121 is secured through the lower eyehole 117.

The solar illuminator system 200, as with the other illuminator systems described herein, comprises an LED array 122 having a series of LED's 124. With respect to the entirety of the electrical configuration of the solar illuminator system 200, the configuration differs somewhat from the other embodiments described herein. More specifically, in the illuminator system 200, each of the LED's 124 can be made to essentially operate in a “stand alone” configuration, separate from others of the LED's 124. That is, and as specifically shown in FIG. 6, each of the individual LED's 124 has, associated therewith, a separate battery pack 202. These individual battery packs 202 take the place of the battery packs 138 previously described with respect to other illuminator system embodiments.

The battery packs 202 can be connected to individual solar panels or lens 204. These connections can be made in electrical circuit configurations as previously described herein. That is, the solar panels 204 can be made to collect electrical energy from the environment during daylight hours, and store the energy in batteries of the battery packs 202 during this time. As further shown in FIG. 6, there is a separate solar panel or solar panel array 204 associated with each individual battery pack 202. Each individual battery pack 202, in turn, is associated with a single LED 124. At night time, batteries associated with the battery packs 202 will provide energy to illuminate each of the LED's 124, in the same manner as previously described herein with respect to the battery packs 138 and LED's 124 associated with the other embodiments of illuminator systems in accordance with the invention. Still further, FIG. 6 also illustrates individual circuit boards 206 which may be associated with each of the individual battery packs 202, LED's 124 and solar panels or solar panel arrays 204. These individual circuit boards take the place of the circuit boards 132 described with respect to the other embodiments of the solar illuminator systems previously described herein.

It will be apparent to those skilled in the pertinent arts that other embodiments of solar illuminator systems in accordance with the invention can be designed. That is, the principles of solar illuminator systems in accordance with the invention are not limited to the specific embodiments described herein. Accordingly, it will be apparent to those skilled in the art that modifications and other variations of the above-described illustrative embodiments of the invention may be effected without departing from the spirit and scope of the novel concepts of the invention.

1. A universal solar illuminator system is adapted to be mounted to a flagpole apparatus having a flagpole and flag, said illuminator system comprising:
an elongated structure in the form of a cylindrical shell opening outwardly and exposing a recessed area with a rear curved surface;
an LED network having a series of LED's disposed in a vertical configuration, said recessed area being formed in front of said LED's;
a DC circuit;
a pair of solar panels;
a battery pack, with said solar panels charging said battery pack during daylight conditions; and
said battery pack energizing said LED's through said DC circuit during nighttime conditions.
